(19) United States
(12) Patent Application Publication
(10) Pub. No.: US 2019/0249625 A1
(43) Pub. Date: Aug. 15, 2019

(54) CONCENTRATED OXYGEN SUPPLIED ENGINE SYSTEM

(71) Applicant: Thomas Zima, Lubbock, TX (US)

(72) Inventor: Thomas Zima, Lubbock, TX (US)

(21) Appl. No.: 15/894,448

(22) Filed: Feb. 12, 2018

(51) Int. Cl. F02M 25/12; F02M 35/024; F02M 35/10

(52) U.S. Cl. CPC F02M 25/12; F02M 35/10144; F02M 35/024

(57) ABSTRACT

A concentrated oxygen supplied engine system for enhancing fuel combustion includes an engine and a concentrating module. The concentrating module is configured to generate concentrated oxygen from air. The concentrating module is coupled to an air supply assembly of the engine so that the concentrating module is positioned to supply the concentrated oxygen through the air supply assembly to combustion chambers of the engine to enhance combustion of fuel that is positioned in the combustion chambers.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to engine systems and more particularly pertains to a new engine system for enhancing fuel combustion.

### BRIEF SUMMARY OF THE INVENTION

An embodiment of the disclosure meets the needs presented above by generally comprising an engine and a concentrating module. The concentrating module is configured to generate concentrated oxygen from air. The concentrating module is coupled to an air supply assembly of the engine so that the concentrating module is positioned to supply the concentrated oxygen through the air supply assembly to combustion chambers of the engine to enhance combustion of fuel that is positioned in the combustion chambers.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a concentrated oxygen supplied engine system according to an embodiment of the disclosure.

FIG. 2 is an in-use view of an embodiment of the disclosure.

FIG. 3 is a block diagram of an embodiment of the disclosure.

FIG. 4 is a block diagram of an embodiment of the disclosure.

FIG. 5 is a block diagram of an embodiment of the disclosure.

### DETAILED DESCRIPTION OF THE INVENTION

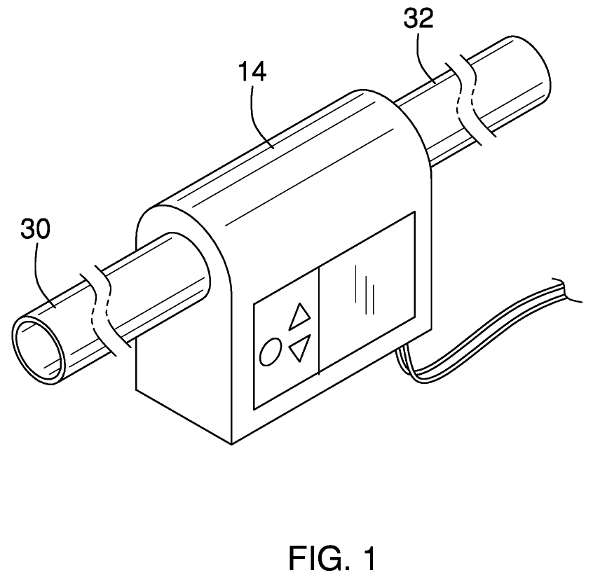

With reference now to the drawings, and in particular to FIGS. 1 through 5 thereof, a new engine system embodying the principles and concepts of an embodiment of the disclosure and generally designated by the reference numeral 10 will be described.

As best illustrated in FIGS. 1 through 5, the engine system 10 generally comprises an engine 12 and a concentrating module 14. The engine 12 comprises an air supply assembly 16, which in turn comprises an air intake 18, a filter mixing box 20, and an air-fuel intake manifold 22. The filter mixing box 20 is coupled to the air intake 18. The filter mixing box 20 is in fluidic communication with the air intake 18. The air-fuel intake manifold 22 is coupled to the filter mixing box 20 and to combustion chambers 24 of the engine 12. The air-fuel intake manifold 22 is in fluidic communication with both the filter mixing box 20 and the combustion chambers 24.

The concentrating module 14 is configured to generate concentrated oxygen from air. The concentrating module 14 comprises components that are well known to those skilled in the art of gas separation. The concentrating module 14 is coupled to the air supply assembly 16 of the engine 12 so that the concentrating module 14 is positioned to supply the concentrated oxygen through the air supply assembly 16 to the combustion chambers 24 to enhance combustion of fuel that is positioned in the combustion chambers 24. Enhancement of the combustion of the fuel will provide increased fuel efficiency, increased power generation, and decreased emissions.

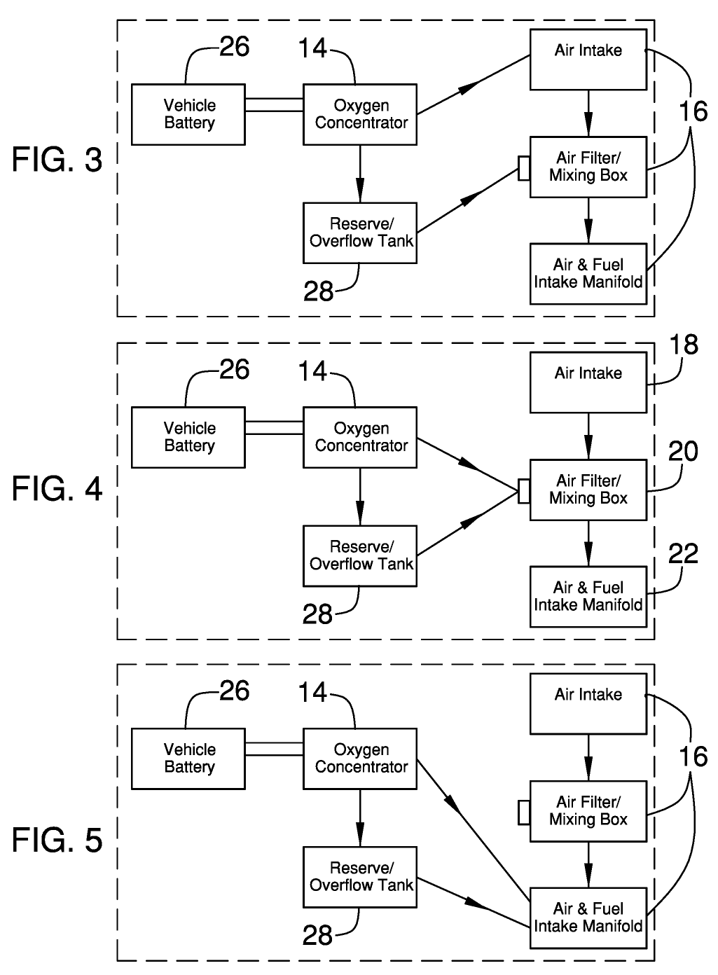

The concentrating module 14 may be positioned to deliver the concentrated oxygen at various points in the standard process of providing air to the engine 12 to increase the oxidizing potential of the air. In a first example, shown in FIG. 3, the concentrating module 14 is coupled to the air intake 18 so that the concentrating module 14 is in fluidic communication with the air intake 18. The concentrating module 14 is positioned to supply the concentrated oxygen to the air intake 18. The oxygen-enriched air passes through the filter mixing box 20 and the air-fuel intake manifold 22 into the combustion chambers 24 of the engine 12 to enhance combustion of the fuel that is positioned in the combustion chambers 24.

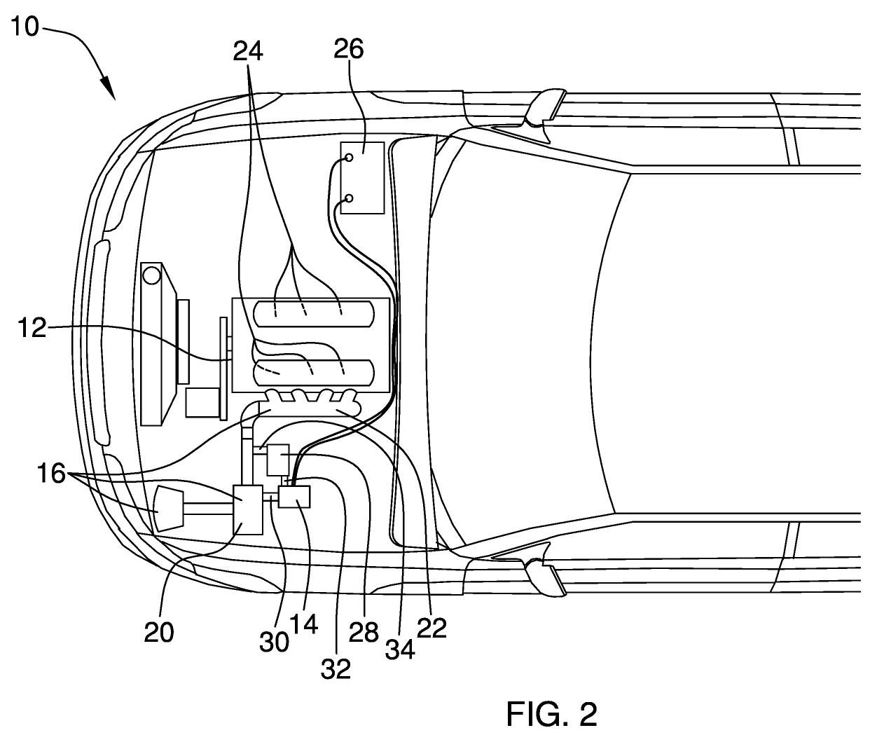

In a second example, shown in FIGS. 2 and 4, the concentrating module 14 is coupled to the filter mixing box 20 so that the concentrating module 14 is in fluidic communication with the filter mixing box 20. The concentrating module 14 is positioned to supply the concentrated oxygen to the filter mixing box 20. The oxygen-enriched air passes through the air-fuel intake manifold 22 into the combustion chambers 24 of the engine 12 to enhance combustion of the fuel that is positioned in the combustion chambers 24.

In a third example, shown in FIG. 5, the concentrating module 14 is coupled directly to the air-fuel intake manifold 22 so that the concentrating module 14 is in fluidic communication with the air-fuel intake manifold 22. The concentrating module 14 is positioned to supply the concentrated oxygen to the air-fuel intake manifold 22. The oxygen-enriched air passes through the air-fuel intake manifold 22 into the combustion chambers 24 of the engine 12 to enhance combustion of the fuel that is positioned in the combustion chambers 24.

A battery 26 is operationally coupled to both the concentrating module 14 and the engine 12, as shown in FIG. 2. The engine 12 is positioned to recharge the battery 26. The battery 26 is positioned to power the concentrating module 14.

A reservoir 28 is coupled to the concentrating module 14 and to the air supply assembly 16, as shown in FIG. 2. The reservoir 28 is in fluidic communication with both the concentrating module 14 and the air supply assembly 16. The reservoir 28 is positioned to receive and store the concentrated oxygen produced by the concentrating module 14. The reservoir 28 is positioned to supply the concentrated oxygen through the air supply assembly 16 to the combustion chambers 24 of the engine 12 to enhance the combustion of the fuel that is positioned in the combustion chambers 24.

As with the concentrating module 14, the reservoir 28 may be positioned to deliver the concentrated oxygen at various points in the standard process of providing air to the engine 12 to increase the oxidizing potential of the air. In a first example, shown in both FIGS. 3 and 4, the reservoir 28 is coupled to the filter mixing box 20 so that the reservoir 28 is in fluidic communication with the filter mixing box 20. The reservoir 28 is positioned to supply the concentrated oxygen to the filter mixing box 20. The oxygen-enriched air passes through the air-fuel intake manifold 22 into the combustion chambers 24 of the engine 12 to enhance combustion of the fuel that is positioned in the combustion chambers 24.

In a second example, shown in FIG. 5 the reservoir 28 is coupled to the air-fuel intake manifold 22 so that the reservoir 28 is in fluidic communication with the air-fuel intake manifold 22. The reservoir 28 is positioned to supply the concentrated oxygen to the air-fuel intake manifold 22. The oxygen-enriched air passes through the air-fuel intake manifold 22 into the combustion chambers 24 of the engine 12 to enhance combustion of the fuel that is positioned in the combustion chambers 24.

A first pipe 30 is coupled to and extends between the concentrating module 14 and the air supply assembly 16. The first pipe 30 is positioned to direct flow of the concentrated oxygen from the concentrating module 14 to the air supply assembly 16. As shown in FIG. 2, the first pipe 30 extends between the concentrating module 14 and the filter mixing box 20.

A second pipe 32 is coupled to and extends between the concentrating module 14 and the reservoir 28, as shown in FIG. 2. The second pipe 32 is positioned to direct flow of the concentrated oxygen from the concentrating module 14 to the reservoir 28.

A third pipe 34 is coupled to and extends between the reservoir 28 and the air supply assembly 16. The third pipe 34 is positioned to direct flow of the concentrated oxygen from the reservoir 28 to the air supply assembly 16. As shown in FIG. 2, the third pipe 34 extends between the reservoir 28 and the air-fuel intake manifold 22.

In use, the concentrating module 14 is positioned to supply the concentrated oxygen to the air supply assembly 16. The oxygen-enriched air passes into the combustion chambers 24 of the engine 12 to enhance combustion of the fuel that is positioned in the combustion chambers 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A concentrated oxygen supplied engine system comprising:
an engine;
a concentrating module configured for generating concentrated oxygen from air, said concentrating module being coupled to an air supply assembly of said engine; and
wherein said concentrating module is positioned for supplying the concentrated oxygen through said air supply assembly to combustion chambers of said engine for enhancing combustion of fuel positioned in said combustion chambers.

2. The system of claim 1, further including a battery operationally coupled to said concentrating module and said engine wherein said engine is positioned for recharging said battery such that said battery is positioned for powering said concentrating module.

3. The system of claim 1, further including said air supply assembly comprising:
an air intake, said concentrating module being coupled to said air intake such that said concentrating module is in fluidic communication with said air intake;
a filter mixing box coupled to said air intake such that said filter mixing box is in fluidic communication with said air intake;
an air-fuel intake manifold coupled to said filter mixing box and said combustion chambers such that said air-fuel intake manifold is in fluidic communication with said filter mixing box and said combustion chambers; and
wherein said concentrating module is positioned for supplying the concentrated oxygen to said air intake such that oxygen-enriched air passes through said filter mixing box and said air-fuel intake manifold into said combustion chambers of said engine for enhancing combustion of the fuel positioned in said combustion chambers.

4. The system of claim 3, further including said concentrating module being coupled to said filter mixing box such that said concentrating module is in fluidic communication with said filter mixing box wherein said concentrating module is positioned for supplying the concentrated oxygen to said filter mixing box such that the oxygen-enriched air passes through said air-fuel intake manifold into said combustion chambers of said engine for enhancing combustion of the fuel positioned in said combustion chambers.

5. The system of claim 3, further including said concentrating module being coupled to said air-fuel intake manifold such that said concentrating module is in fluidic communication with said air-fuel intake manifold wherein said concentrating module is positioned for supplying the concentrated oxygen to air-fuel intake manifold such that oxygen-enriched air passes through said air-fuel intake manifold into said combustion chambers of said engine for enhancing combustion of the fuel positioned in said combustion chambers.

6. The system of claim 3, further including a reservoir coupled to said concentrating module and to said air supply assembly such that said reservoir is in fluidic communication with said concentrating module and said air supply assembly wherein said reservoir is positioned for receiving and storing the concentrated oxygen produced by said concentrating module and for supplying the concentrated oxygen through said air supply assembly to said combustion chambers of said engine for enhancing the combustion of the fuel positioned in said combustion chambers.

7. The system of claim 6, further including said reservoir being coupled to said filter mixing box such that said such that said reservoir is in fluidic communication with said filter mixing box wherein said reservoir is positioned for supplying the concentrated oxygen to said filter mixing box such that the oxygen-enriched air passes through said air-fuel intake manifold into said combustion chambers of said engine for enhancing combustion of the fuel positioned in said combustion chambers.

8. The system of claim 6, further including said reservoir being coupled to said air-fuel intake manifold such that said such that said reservoir is in fluidic communication with said air-fuel intake manifold wherein said reservoir is positioned for supplying the concentrated oxygen to said air-fuel intake manifold such that the oxygen-enriched air passes through said air-fuel intake manifold into said combustion chambers of said engine for enhancing combustion of the fuel positioned in said combustion chambers.

9. The system of claim 1, further comprising:
a first pipe coupled to and extending between said concentrating module and said air supply assembly wherein said first pipe is positioned for directing flow of the concentrated oxygen from said concentrating module to said air supply assembly;
a second pipe coupled to and extending between said concentrating module and said reservoir wherein said second pipe is positioned for directing flow of the concentrated oxygen from said concentrating module to said reservoir;
a third pipe coupled to and extending between said reservoir and said air supply assembly wherein said third pipe is positioned for directing flow of the concentrated oxygen from said reservoir to said air supply assembly.

10. A concentrated oxygen supplied engine system comprising:
an engine comprising an air supply assembly, said air supply assembly comprising:
an air intake,
a filter mixing box coupled to said air intake such that said filter mixing box is in fluidic communication with said air intake, and
an air-fuel intake manifold coupled to said filter mixing box and combustion chambers of said engine such that said air-fuel intake manifold is in fluidic communication with said filter mixing box and said combustion chambers;
a concentrating module configured for generating concentrated oxygen from air, said concentrating module being coupled to an air supply assembly of said engine wherein said concentrating module is positioned for supplying the concentrated oxygen through said air supply assembly to said combustion chambers for enhancing combustion of fuel positioned in said combustion chambers, said concentrating module being coupled to said air intake such that said concentrating module is in fluidic communication with said air intake wherein said concentrating module is positioned for supplying the concentrated oxygen to said air intake such that oxygen-enriched air passes through said filter mixing box and said air-fuel intake manifold into said combustion chambers of said engine for enhancing combustion of the fuel positioned in said combustion chambers;
a battery operationally coupled to said concentrating module and said engine wherein said engine is positioned for recharging said battery such that said battery is positioned for powering said concentrating module;
a reservoir coupled to said concentrating module and to said air supply assembly such that said reservoir is in fluidic communication with said concentrating module and said air supply assembly wherein said reservoir is positioned for receiving and storing the concentrated oxygen produced by said concentrating module and for supplying the concentrated oxygen through said air supply assembly to said combustion chambers of said engine for enhancing the combustion of the fuel positioned in said combustion chambers, said reservoir being coupled to said filter mixing box such that said such that said reservoir is in fluidic communication with said filter mixing box wherein said reservoir is positioned for supplying the concentrated oxygen to said filter mixing box such that the oxygen-enriched air passes through said air-fuel intake manifold into said combustion chambers of said engine for enhancing combustion of the fuel positioned in said combustion chambers;
a first pipe coupled to and extending between said concentrating module and said air supply assembly wherein said first pipe is positioned for directing flow of the concentrated oxygen from said concentrating module to said air supply assembly;
a second pipe coupled to and extending between said concentrating module and said reservoir wherein said second pipe is positioned for directing flow of the concentrated oxygen from said concentrating module to said reservoir;
a third pipe coupled to and extending between said reservoir and said air supply assembly wherein said third pipe is positioned for directing flow of the concentrated oxygen from said reservoir to said air supply assembly; and
wherein said concentrating module is positioned for supplying the concentrated oxygen to said air supply assembly such that oxygen-enriched air passes into said combustion chambers of said engine for enhancing combustion of the fuel positioned in said combustion chambers.

11. The system of claim 10, further including said concentrating module being coupled to said filter mixing box such that said filter mixing box is in fluidic communication with said filter mixing box wherein said concentrating module is positioned for supplying the concentrated oxygen to said filter mixing box such that the oxygen-enriched air passes through said air-fuel intake manifold into said combustion chambers of said engine for enhancing combustion of the fuel positioned in said combustion chambers.

12. The system of claim 10, further including said concentrating module being coupled to said air-fuel intake manifold such that said concentrating module is in fluidic communication with said air-fuel intake manifold wherein said concentrating module is positioned for supplying the concentrated oxygen to air-fuel intake manifold such that oxygen-enriched air passes through said air-fuel intake manifold into said combustion chambers of said engine for enhancing combustion of the fuel positioned in said combustion chambers.

13. The system of claim 10, further including said reservoir being coupled to said air-fuel intake manifold such that said such that said reservoir is in fluidic communication with said air-fuel intake manifold wherein said reservoir is positioned for supplying the concentrated oxygen to said air-fuel intake manifold such that the oxygen-enriched air passes through said air-fuel intake manifold into said combustion chambers of said engine for enhancing combustion of the fuel positioned in said combustion chambers.
